(19) United States
(12) Patent Application Publication
(10) Pub. No.: US 2026/0213588 A1
(43) Pub. Date: Jul. 23, 2026

(54) STATOR CORE

(71) Applicants: TOYOTA JIDOSHA KABUSHIKI KAISHA, Toyota-shi (JP); MITSUI HIGH-TEC, INC., Kitakyushu-shi (JP)

(72) Inventors: Fumiaki YAMATO, Okazaki-shi (JP); Junichi DEGUCHI, Toyota-shi (JP); Keiichi KANESHIGE, Seto-shi (JP); Kazuya HISATSUNE, Toyota-shi (JP); Shohei YOSHISAKO, Kitakyushu-shi (JP)

(73) Assignees: TOYOTA JIDOSHA KABUSHIKI KAISHA, Toyota-shi (JP); MITSUI HIGH-TEC, INC., Kitakyushu-shi (JP)

(21) Appl. No.: 19/406,006

(22) Filed: Dec. 2, 2025

(30) Foreign Application Priority Data
Jan. 21, 2025 (JP) 2025-008400

(51) Int. Cl. H02K 1/16

(52) U.S. Cl. CPC H02K 1/16

(57) ABSTRACT

A stator core includes a plurality of divided cores arranged in a circumferential direction, in an annular shape, in which, among the divided cores, a pair of divided cores adjacent to each other includes a pair of end faces in contact with each other in the circumferential direction, a pair of grooves fashioned on the end faces facing each other, and resin filled in the grooves, and the grooves extend in an axial direction of the annular shape and narrow down in width toward the end faces.

### CROSS-REFERENCE TO RELATED APPLICATION

This application claims priority to Japanese Patent Application No. 2025-008400 filed on January 21, 2025. The disclosure of the above-identified application, including the specification, drawings, and claims, is incorporated by reference herein in its entirety.

### BACKGROUND

### 1. Technical Field

The present disclosure relates to a stator core.

### 2. Description of Related Art

Japanese Unexamined Patent Application Publication No. 2011-259661 (JP 2011-259661 A), for example, describes, with respect to a stator core for a rotating electrical machine, an annular stator core having a plurality of divided cores. The divided cores are disposed adjacent to each other in a circumferential direction of the stator core, in an annular array. To secure the individual divided cores to each other, an annular ring member is attached to an outer peripheral face of the stator core by shrink fitting or press fitting.

### SUMMARY

When the ring member is shrink-fitted or press-fitted to the divided cores, distortion or misalignment occurs in the divided cores, causing excessive concentration of magnetic flux in one part of the stator core. Accordingly, there is a concern that this might increase iron loss of the stator core. When the iron loss in the stator core of a rotating electrical machine installed in, for example, a battery electric vehicle or a hybrid electric vehicle increases, there is a concern that the electric mileage when traveling will deteriorate.

Accordingly, the present disclosure has been made in light of the above problem, and an object thereof is to provide a stator core that can reduce iron loss.

A stator core according to the present disclosure includes a plurality of divided cores arranged in a circumferential direction, in an annular shape, in which, among the divided cores, a pair of divided cores adjacent to each other includes a pair of end faces in contact with each other in the circumferential direction, a pair of grooves provided on the end faces facing each other, and resin filled in the grooves, and the grooves extend in an axial direction of the annular shape and narrow down in width toward the end faces.

In the above stator core, the stator core may include a yoke that is annular, and a plurality of teeth protruding from an inner edge of the yoke toward the center of the annular shape, and the grooves may be provided in the yoke.

In the above stator core, the grooves may be provided at a position closer to an outer edge of the yoke than to the inner edge of the yoke.

In the above stator core, one of the end faces may include a protrusion that protrudes in the circumferential direction, the other of the end faces may include a recess that is recessed in the circumferential direction, the protrusion and the recess may extend in the axial direction of the stator core, and the protrusion may engage with the recess.

According to the present disclosure, iron loss of the stator core can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically exemplifying a rotating electrical machine;

FIG. 2 is a perspective view exemplifying a stator core;

FIG. 3 is a plan view illustrating a vicinity of a boundary of divided cores in frontal view, along an axial direction;

FIG. 4A is a cross-sectional view of the vicinity of the boundary of the divided cores taken along line A-A in FIG. 3;

FIG. 4B is a cross-sectional view of the vicinity of the boundary of the divided cores taken along line B-B in FIG. 3; and

FIG. 5 is a diagram exemplifying divided cores having two sets of grooves.

### DETAILED DESCRIPTION OF EMBODIMENTS

### Configuration of Rotating Electrical Machine

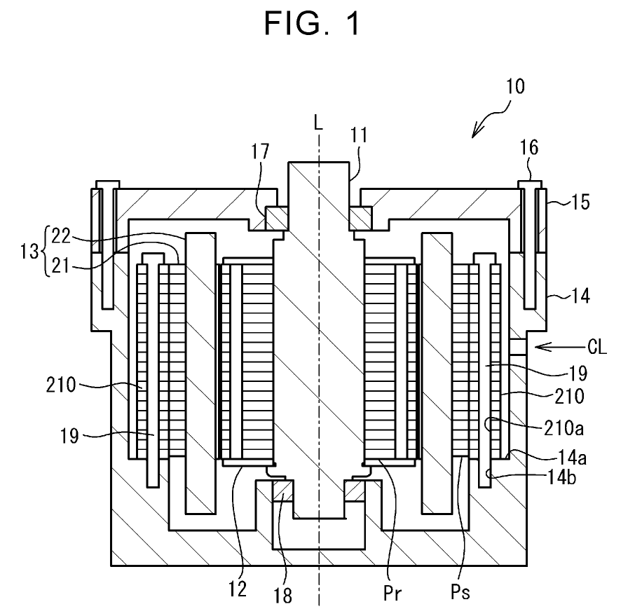

FIG. 1 is a cross-sectional view schematically exemplifying a rotating electrical machine 10. The rotating electrical machine 10 is a permanent magnet type synchronous multi-phase alternating current motor with an inner rotor structure. The rotating electrical machine 10 is used as a drive source for, for example, a hybrid electric vehicle or a battery electric vehicle.

FIG. 1 is a longitudinal-sectional view of the rotating electrical machine 10, taken along a rotating shaft 11. In the following description, a direction in which the rotating shaft 11 extends will be referred to as “axial direction L”. Also, a direction extending radially from the rotating shaft 11 and also perpendicularly to the rotating shaft 11 will be referred to as “radial direction”, and a direction extending circumferentially about the rotating shaft 11 will be referred to as a circumferential direction. Note that the axial direction L is an example of the axial direction of an annular shape, and the circumferential direction is an example of the circumferential direction of the annular shape.

The rotating electrical machine 10 includes a rotor 12, a stator 13, a housing 14, and a cover 15. The rotor 12 is fixed to the rotating shaft 11. The stator 13 has a substantially cylindrical shape, and surrounds the rotor 12. The housing 14 accommodates the rotor 12 and the stator 13. The cover 15 is fixed to one end side of the housing 14 in the axial direction L.

The rotor 12 and the stator 13 are disposed coaxially, in a state facing each other in the radial direction. The rotor 12 and the stator 13 have a laminated structure in which magnetic steel plates Pr and Ps, which are magnetic substances, are stacked in the axial direction L, respectively. The individual electromagnetic steel plates Pr and Ps are formed by punching out sheet-like electromagnetic steel plates for manufacturing, by pressing thereof using a predetermined die.

The housing 14 is a cylindrical member with a bottom, opening at one end side in the axial direction L. The cover 15 is attached to an opening end portion of the housing 14 by a plurality of bolts 16. The housing 14 and the cover 15 are provided with bearings 17 and 18. The bearings 17 and 18 rotatably support the rotating shaft 11 and the rotor 12.

The housing 14 is provided with a base portion 14a to which the stator 13 is fixed. The base portion 14a has screw holes 14b extending in the axial direction L. The stator 13 has a stator core 21 and windings 22. The stator core 21 includes fixing portions 210 for fixing to the base portion 14a. Fixing bolts 19 are inserted into insertion holes 210a of the fixing portions 210 and screwed into the screw holes 14b. Thus, the stator core 21 is fixed to the housing 14 so as to abut against an end face of the base portion 14a in the axial direction L thereof.

The windings 22 are wound onto the stator core 21. The windings 22 include a U-phase winding, a V-phase winding, and a W-phase winding. One end portion of the winding for each phase is connected to a power line bus bar (omitted from illustration) for that phase, and the other end portion is connected to a neutral line bus bar (omitted from illustration).

The rotating electrical machine 10 has a cooling structure in the housing 14 that uses a coolant such as lubricating oil or the like. For example, coolant CL is supplied from an upper side of the housing 14 and the coolant CL flows along an outer peripheral face of the stator 13, thereby cooling the stator 13.

### Configuration of Stator Core

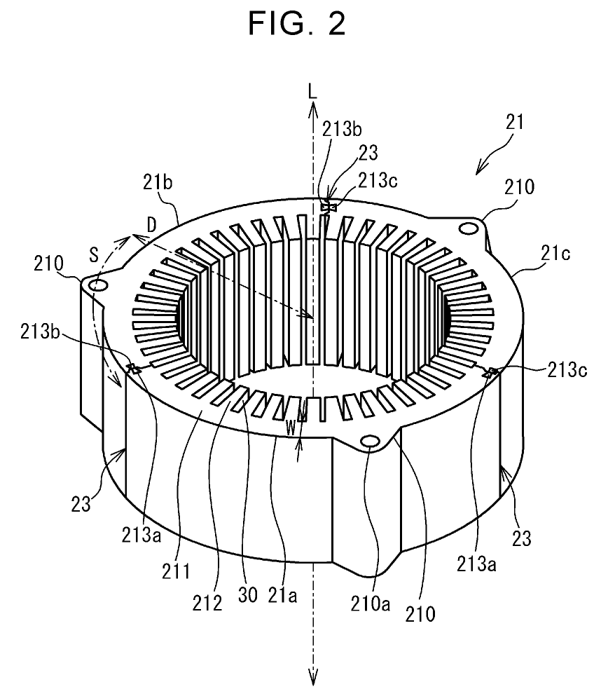

FIG. 2 is a perspective view exemplifying the stator core 21. The stator core 21 has an annular shape. The stator core 21 includes a yoke 211 that is annular in shape, and a plurality of teeth 212 each having a substantially square prism shape. The teeth 212 protrude in a radial direction D from an inner edge of the yoke 211. The teeth 212 are provided at equal intervals on an inner peripheral face of the yoke 211. Note that the stator core 21 is not limited to an annular shape, and may be another ring shape.

A slot 30 is provided between a pair of teeth 212 adjacent to each other. The winding 22 for each phase is wound around each tooth 212 through the slots 30. Accordingly, when the windings 22 are energized, a magnetic flux is generated within the stator core 21. The magnetic flux changes as the rotor 12 rotates.

The yoke 211 has a substantially constant width W in the radial direction D. Three fixing portions 210, as one example, are provided at equal intervals on an outer peripheral face of the yoke 211. The yoke 211 is formed integrally with the fixing portions 210 and the teeth 212, but the fixing portions 210 are not limited to this, and may be formed separately from the yoke 211 and joined to the yoke 211.

The stator core 21 is formed by linking three divided cores 21a to 21c arrayed in a circumferential direction S, as one example. Each of the divided cores 21a to 21c corresponds to a region that is one-third of the entire circular ring of the stator core 21. That is to say, the divided cores 21a to 21c correspond to a fan-shaped arcuate region with a central angle of 120 degrees as viewed from the axial direction L of the center axis. The fixing portions 210 are provided on each of the divided cores 21a to 21c. Note that the number of the divided cores 21a to 21c is not limited to three, and may be two, or four or more.

The yoke 211 of each of the divided cores 21a to 21c has end faces along boundary lines 23 between the divided cores 21a to 21c in the circumferential direction S. The end faces of the divided cores 21a to 21c that are adjacent to each other are in direct contact with each other. The boundary lines 23 extend from slots 30 in the radial direction D, and cross the yoke 211 without passing through the teeth 212. Setting the boundary lines 23 in this way enables the area of the end faces of boundary regions between the divided cores 21a to 21c to be reduced as compared to when the boundary lines 23 pass through the teeth 212 and the yoke 211. Note, however, that the boundary lines 23 are not limited to this, and may be provided so as to pass through the teeth 212 and the yoke 211.

Also, each of the divided cores 21a to 21c has grooves 213a to 213c on two end faces thereof, respectively. The grooves 213a to 213c of the divided cores 21a to 21c that are adjacent to each other are in direct contact with each other at the boundary lines 23. Also, the grooves 213a to 213c are each filled with resin. This enables the divided cores 21a to 21c to be linked to each other without providing the ring members described above on the outer peripheries of the divided cores 21a to 21c. Accordingly, distortion and misalignment of the divided cores 21a to 21c are reduced compared to when ring members are used.

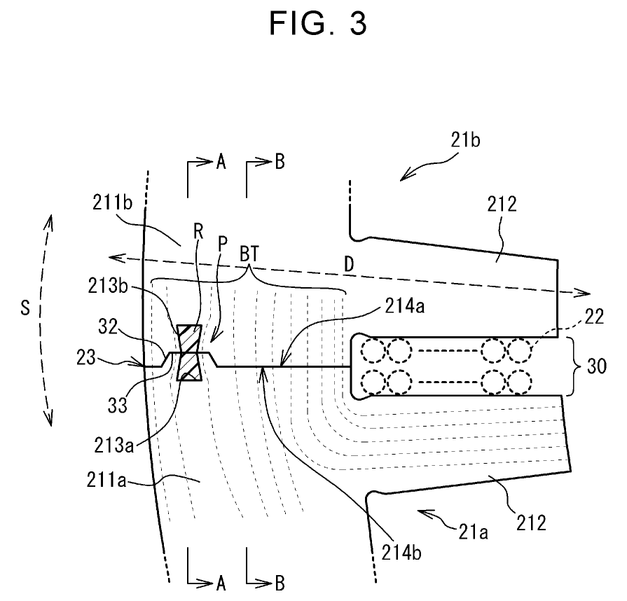

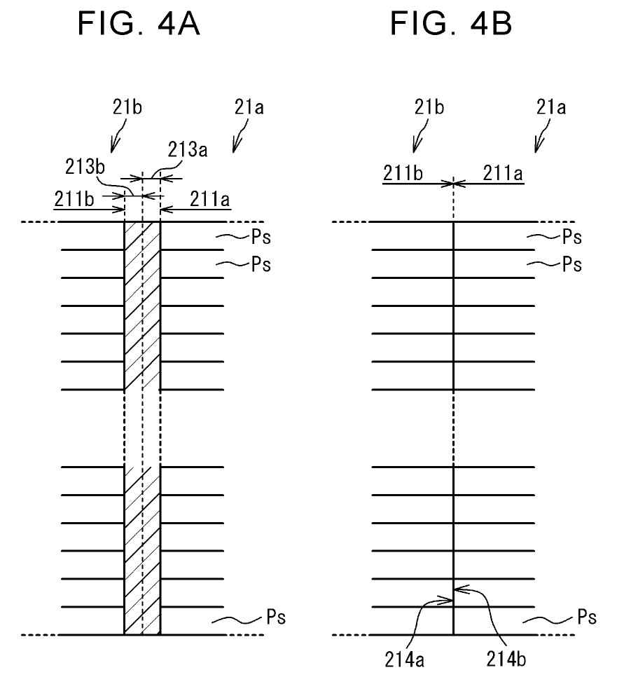

FIG. 3 is a plan view illustrating a vicinity of a boundary of the divided cores 21a and 21b in frontal view, along the axial direction L. Also, FIG. 4A is a cross-sectional view of the vicinity of the boundary of the divided cores 21a and 21b taken along line A-A in FIG. 3, and FIG. 4B is a cross-sectional view of the vicinity of the boundary of the divided cores 21a and 21b taken along line B-B in FIG. 3. In FIGS. 3, 4A, and 4B, the same components as those in FIG. 2 are denoted by the same reference numerals, and description thereof will be omitted.

The divided cores 21a and 21b are adjacent to each other. The boundary line 23 between the divided cores 21a and 21b extends from the slot 30 substantially along the radial direction D toward the outer periphery. The divided cores 21a and 21b each have one or more teeth 212 and yoke portions 211a and 211b that are arcuate. The yoke portions 211a and 211b are parts of the yoke 211 and extend in the circumferential direction S.

End faces 214a and 214b of the divided cores 21a and 21b in the circumferential direction S are provided along the boundary line 23 and the axial direction L. The end faces 214a and 214b are situated at one end of the yoke portions 211a and 211b in the circumferential direction S, respectively. The end face 214a of one divided core 21a and the end face 214b of the other divided core 21b are in contact with each other in the circumferential direction S.

A protrusion 32 protruding in the circumferential direction S is provided on the end face 214a of the divided core 21a, and a recess 33 recessed in the circumferential direction S is provided on the end face 214b of the divided core 21b. The protrusion 32 and the recess 33 are formed to extend in the axial direction L, and the protrusion 32 is engaged with the recess 33. This facilitates positioning of the divided cores 21a and 21b as compared to when the protrusion 32 and the recess 33 are not provided. When the divided cores 21a, 21b are viewed in frontal view along the axial direction L, the protrusion 32 and the recess 33 have, for example, a trapezoidal shape, but are not limited to this and may have other shapes such as a rectangle or the like.

Also, the groove 213a is provided in the end face 214a of one divided core 21a, and the groove 213b is provided in the end face 214b of the other divided core 21b. As an example, the grooves 213a and 213b are provided in the protrusion 32 and the recess 33 of the end faces 214a and 214b, respectively. The grooves 213a and 213b extend in the axial direction L and are filled with a resin R.

When the divided cores 21a and 21b are viewed in front view along the axial direction L, the grooves 213a and 213b each have a generally trapezoidal shape, with the shorter side of the upper base and the lower base being open. The grooves 213a and 213b are formed in the end faces 214a and 214b, respectively, so as to face each other. Accordingly, open faces of the grooves 213a and 213b are the same.

The widths of the grooves 213a and 213b narrow toward the end faces 214a and 214b, respectively, and a combined shape of the grooves 213a and 213b is generally bowtie-shaped. That is to say, widths of the grooves 213a and 213b become narrower as they approach the boundary line 23 between the divided cores 21a and 21b. Thus, the resin R in the grooves 213a and 213b functions as substantially bowtie-shaped connecting means, connecting the divided cores 21a and 21b to each other.

As illustrated in FIG. 4A, the grooves 213a and 213b are provided on the end faces 214a and 214b along the axial direction L over all layers of the electromagnetic steel sheet Ps. The grooves 213a and 213b are filled with the resin R, and accordingly the divided cores 21a and 21b are connected to each other by the resin R in substantially trapezoidal shapes in the grooves 213a and 213b. The resin R in the grooves 213a and 213b narrows down in width toward the end faces 214a and 214b, and accordingly even when an external force acts in the circumferential direction S to separate the divided cores 21a and 21b from each other, the resin R is not readily detached from the grooves 213a and 213b, and the connection of the divided cores 21a and 21b to each other can be maintained.

In this way, the divided cores 21a and 21b are connected to each other by the resin R in the grooves 213a and 213b, without the ring members described above being provided. Accordingly, distortion and misalignment of the divided cores 21a to 21c are reduced, and iron loss of the stator core 21 is reduced.

The resin R is, for example, a thermosetting resin or a thermoplastic resin. The thermosetting resin or the thermoplastic resin preferably has suitable strength and adhesion. Note that the resin R is a non-magnetic resin having lower magnetic permeability than the electromagnetic steel sheet Ps.

Magnetic flux BT generated from the winding 22 passes through the rotor 12, and is generated along the circumferential direction S of the yoke 211 from the teeth 212. The magnetic flux BT changes in conjunction with the rotor 12 rotating. Magnetic flux density of a magnetic field is smaller the farther toward the outer edge side in the radial direction D of the stator core 21, and is greater the farther toward the inner edge side.

The resin R has a lower magnetic permeability than the electromagnetic steel sheet Ps, and accordingly substantially does not pass the magnetic flux BT, generated by energizing the winding 22 in the slot 30. Accordingly, the magnetic flux BT circumvents the grooves 213a and 213b. Hence, the magnetic flux is concentrated in the vicinity of the grooves 213a and 213b, and the magnetic flux density becomes higher than at other portions. The higher the magnetic flux density is, the greater the iron loss of the stator core 21 is.

Accordingly, the grooves 213a and 213b are provided at positions closer to the outer edge of the stator core 21 than to the inner edge thereof, in the radial direction D of the stator core 21. Specifically, the grooves 213a and 213b are provided not in the teeth 212 but in the yoke portions 211a and 211b, respectively. Accordingly, the grooves 213a and 213b are provided at positions where the magnetic flux density is low, and accordingly influence of the resin R in the grooves 213a and 213b on the magnetic flux BT is reduced, and increase in iron loss is suppressed.

Further, the grooves 213a and 213b are provided at positions closer to the outer edges of the yoke portions 211a and 211b than to the inner edges thereof, in the radial direction D of the stator core 21. For example, the grooves 213a and 213b are provided on the outer side from the center of the width W of the yoke 211. Accordingly, the grooves 213a and 213b are provided at positions where the magnetic flux density is even lower, and accordingly the influence of the resin R in the grooves 213a and 213b on the magnetic flux BT is reduced, and increase in iron loss is suppressed.

While the configuration in the vicinity of the boundary between the divided cores 21a and 21b has been exemplified so far, the vicinity of the boundary between the divided cores 21a and 21c and the vicinity of the boundary between the divided cores 21b and 21c also have the same configuration. Accordingly, the stator core 21 can connect the divided cores 21a to 21c without necessitating a ring member.

In this example, the divided cores 21a to 21c have the end faces 214a to 214c and the grooves 213a to 213c that are common to all the layers of the electromagnetic steel sheet Ps, but this is not limiting. The divided cores 21a to 21c may have individual end faces 214a to 214c and the grooves 213a to 213c at different positions in the circumferential direction S of the stator core 21, for example, for each layer of a predetermined number of electromagnetic steel sheets Ps adjacent to each other in the axial direction L. Also, there is no limitation on the number of the grooves 213a to 213c.

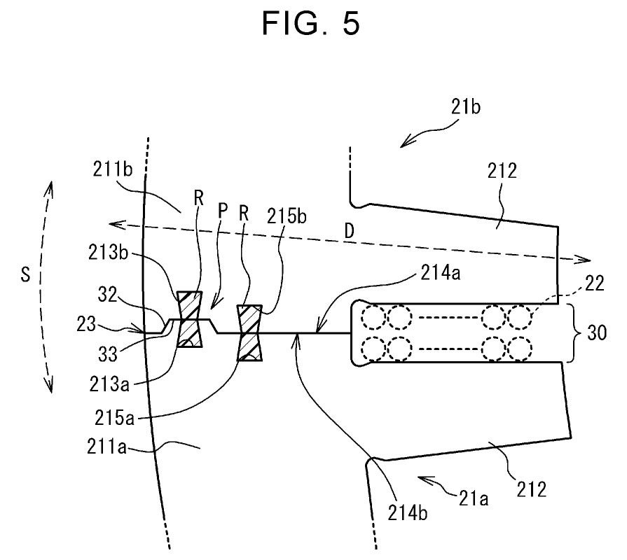

FIG. 5 is a diagram exemplifying the divided cores 21a and 21b each having two sets of grooves 213a and 213b, and 215a and 215b. The stator core 21 of this example has separate grooves 215a and 215b on an inner circumferential side of the grooves 213a and 213b. The grooves 215a and 215b have the same shape as the grooves 213a and 213b, and are filled with the resin R.

Accordingly, the divided cores 21a and 21b are connected by the resin R in the two sets of grooves 213a and 213b, and 215a and 215b. Thus, the divided cores 21a and 21b are connected more firmly than when connected only by the resin R in the grooves 213a and 213b. Note that the resin R may be a magnetic resin containing a metal filler, instead of a non-magnetic resin. In this case, the magnetic flux BT passes through the resin R, and accordingly the magnetic properties of the stator core 21 are improved as compared to when non-magnetic resin is used.

The above-described embodiment is a preferred example of the present disclosure. It should be noted, however, that this is not limiting, and can be carried out modified variously without departing from the spirit of the present disclosure.

What is claimed is:

1. A stator core, comprising a plurality of divided cores arranged in a circumferential direction, in an annular shape, wherein
among the divided cores, a pair of divided cores adjacent to each other includes
a pair of end faces in contact with each other in the circumferential direction,
a pair of grooves provided on the end faces facing each other, and
resin filled in the grooves, and
the grooves extend in an axial direction of the annular shape and narrow down in width toward the end faces.

2. The stator core according to claim 1, wherein
each of the divided cores includes a yoke portion extending in the circumferential direction, and one or more teeth protruding from an inner edge of the yoke portion toward a center of the annular shape, and
the grooves are provided in the yoke portions.

3. The stator core according to claim 2, wherein the grooves are provided at a position closer to an outer edge of the yoke portion than to the inner edge of the yoke portion.

4. The stator core according to claim 1, wherein
one of the end faces includes a protrusion that protrudes in the circumferential direction,
the other of the end faces includes a recess that is recessed in the circumferential direction,
the protrusion and the recess extend in the axial direction, and
the protrusion engages with the recess.
